(19) United States
(12) Patent Application Publication
(10) Pub. No.: US 2016/0112294 A1
(43) Pub. Date: Apr. 21, 2016

(54) FOLLOW ME DASHBOARDS

(71) Applicant: Brocade Communications Systems, Inc., San Jose, CA (US)

(72) Inventors: Arunmani Annamalai, San Jose, CA (US); Aruna Sangli, San Jose, CA (US); Prakash Kaligotla, Milpitas, CA (US)

(21) Appl. No.: 14/517,816

(22) Filed: Oct. 18, 2014

(51) Int. Cl. H04L 12/26; G06F 3/0484; H04L 12/24

(52) U.S. Cl. CPC H04L 43/16; H04L 41/22; G06F 3/0484

(57) ABSTRACT

Parameters corresponding to a network device are monitored by a widget. The widget may be minimized and occupy a portion of a graphic user interface (GUI), wherein the portion maintains visibility over other portion(s) of the GUI. The minimized widget may be configured to display the parameters of the network device when a certain triggering event occurs, as well as alert a user when the context of any other portion of the GUI corresponds to the parameters of the at least one network device being monitored by the widget.

### BACKGROUND OF THE INVENTION

1. Field of the Invention

The invention relates to network device management and more particularly to displaying dashboard or widget parameters relating to the performance of networking devices.

2. Description of the Related Art

Network management software provides network administrators a way of tracking, among other things, the bandwidth and memory utilization of ports on a network. For smaller networks with a fewer number of ports, closely monitoring port utilization in a graphical user interface (GUI) is a less arduous task. However, for large networks, there are often so many ports that the arrangement, organization and display of data values for each port based on predetermined parameters are necessitated. One current solution to this problem, which is widely used, includes utilizing a dashboard or widget in order to track specific parameters of certain devices on a network. A widget allows an administrator to designate specific parameters of certain devices to monitor in a single application window. While this solution aids administrators in keeping track of certain devices and the parameters that an administrator may deem to be most important, an administrator will not always be able to view the widget when he becomes preoccupied with other tasks in the network management software. For example, an administrator may have to configure various network settings, which may prevent the administrator from viewing the widgets. Consequently, this solution does not always allow an administrator to be aware of the status of the devices and the parameters being monitored by the widget. Therefore a method and system to improve the awareness of the administrator regarding network performance is desired.

### SUMMARY OF THE INVENTION

Implementations of the presently disclosed invention relate to ensuring an administrator is aware of network parameters being monitored in a widget, even when the administrator may be preoccupied with something other than the widget. A widget is configured to follow an administrator to various screens in the graphic user interface of network management software in a minimized state. When an administrator is viewing a particular network device or parameter that is being tracked by the widget, the administrator is alerted and the widget information corresponding to the particular network device is displayed by expanding the widget or disclosing only the relevant information.

This technique can be used on any telecommunication network.

### BRIEF DESCRIPTION OF THE FIGURES

The accompanying drawings, which are incorporated in and constitute a part of this specification, illustrate an implementation of apparatus and methods consistent with the present invention and, together with the detailed description, serve to explain advantages and principles consistent with the invention.

FIG. 1 is a diagram illustrating a local area network (LAN) and wide area network (WAN) as may be incorporated together with the present invention.

FIG. 2 is a diagram of an Ethernet Switch that may be incorporated together with the present invention.

FIG. 3 is a diagram illustrating Fibre Channel (FC) storage area network (SAN) fabrics interconnected via a wide area network (WAN) as may be incorporated together with the present invention.

FIG. 4 is a diagram of a Fibre Channel Switch that may be incorporated together with the present invention.

FIG. 5 is a block diagram of a management station connected to a communications network for operating in accordance with the present invention.

FIG. 6 is a screenshot of an example widget or dashboard of a GUI according to prior art where a list of data ports is sorted in descending order based on the port with the highest transmit/receive utilization in the range of 75% to 100% utilization.

FIG. 7 is a screenshot of an example GUI according to the prior art, where numerous widgets or dashboards are shown in a single window.

FIG. 8A is a screenshot of an example GUI according to an embodiment of the present invention, where a widget bar is located on the screen.

FIG. 8B is an example of an example widget bar from FIG. 8A, where the minimized widgets of the widget bar display information about the network.

FIG. 9a is a screenshot of an example GUI according to an embodiment of the present invention, where a network topology is illustrated together with a widget bar.

FIG. 9b is a screenshot of an example GUI according to an embodiment of the present invention where a selected switch corresponds to information being monitored by a particular widget.

### DETAILED DESCRIPTION OF THE PREFERRED EMBODIMENTS

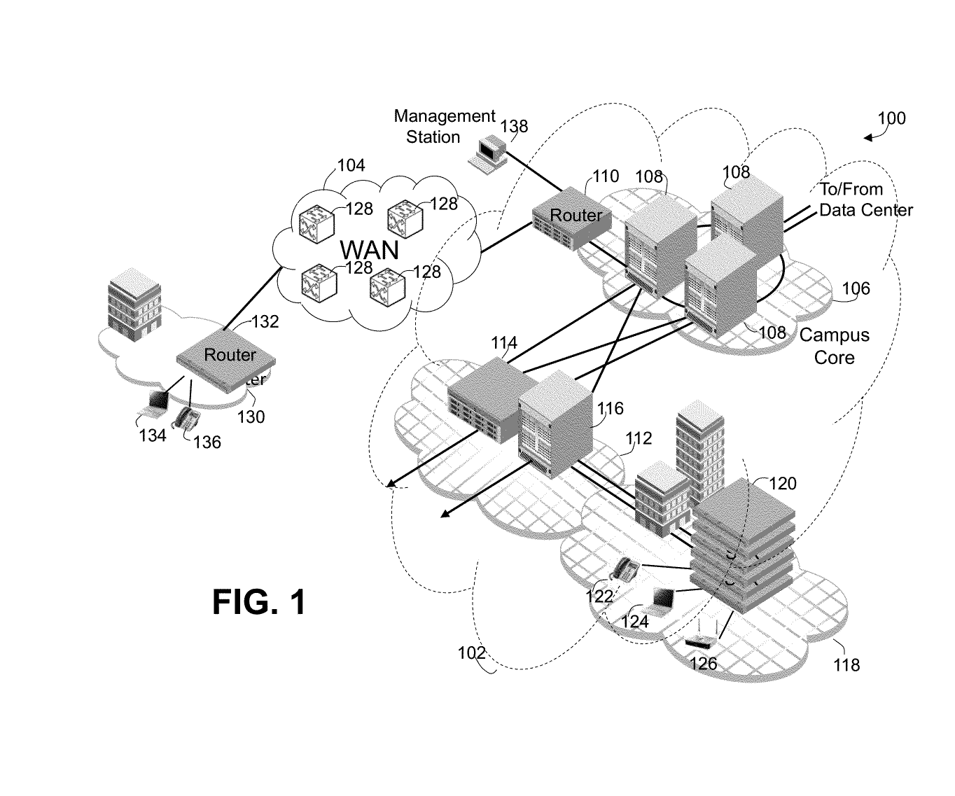

Referring to FIG. 1, an Ethernet network 100 is shown wherein a LAN 102 is interconnected to a remote campus 130 via WAN 104. The campus core 106 includes a plurality of interconnected core switches 108. The core switches 108 are connected to a data center (not shown). A router no is connected to the core switches and the WAN 104. The LAN 102 is connected to the WAN 104 via router 110. The core switches 108 are connected to switches 114 and 116 of an aggregation campus 112. The aggregation campus switches 114 and 116 are connected to switches 120 of large network 118 and provide data communication services to the large network's telephone 122, computer 124, and wireless access 126 devices. The aggregation network switches 114 and 116 may also be connected to additional campuses (not shown) in order to provide additional data communication services. The WAN 104 is comprised of a plurality of interconnected Ethernet switches 128 and other networking devices (not shown). WAN 104 is connected to remote campus 130 via a router 132. Router 132 provides data communication services to computers 134 and telephone devices 136. It is understood that this is an exemplary network and numerous other network topologies can be monitored according to the present invention.

In an embodiment of the present invention a management station 138 is connected to router no of the campus core 106. As will be appreciated by one having ordinary skill in the art, the management station 138 allows a network administrator to monitor the data traffic, port utilization, and various other networking characteristics of each switching device in the Ethernet network 100.

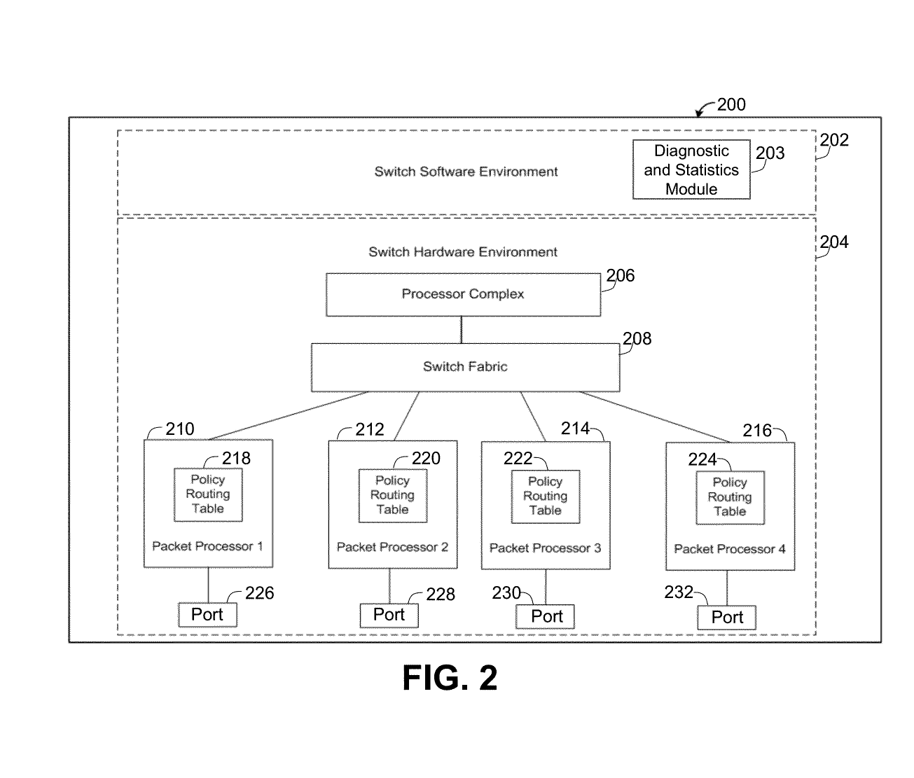

Turning next to FIG. 2, a block diagram of an Ethernet switch or router 200 that may be utilized in Ethernet network 100 is shown. The Ethernet switch 200 comprises a switch software environment 202 and switch hardware environment 204. The software environment 202 includes a diagnostics and statistics module 203 to allow management software access to the various statistical counters in the switch 200, such as receive and transmit rate counters for each port 226, 228, 230, 232. The switch hardware environment 204 has a processor complex 206 that consists of processors as defined. The processor complex 206 is connected to a switch fabric 208, which provides the basic switching operations for the switch 200. The switch fabric 208 is connected to a plurality of packet processors 210, 212, 214, 216. Each packet processor 210, 212, 214, 216 has its own respective policy routing table 218, 220, 22, 224 to provide conventional packet analysis and routing. Each packet processor 210, 212, 214, 216 is connected to its own respective port or ports 226, 228, 230, 232. When the Ethernet switch 200 is implemented in a network such as network 100, the data value of each port 226, 228, 230, and 230 may be monitored and analyzed using management software on a management station, such as management station 136. Again, it is understood that this is an exemplary Ethernet switch architecture and numerous other architectures can be used according to the present invention.

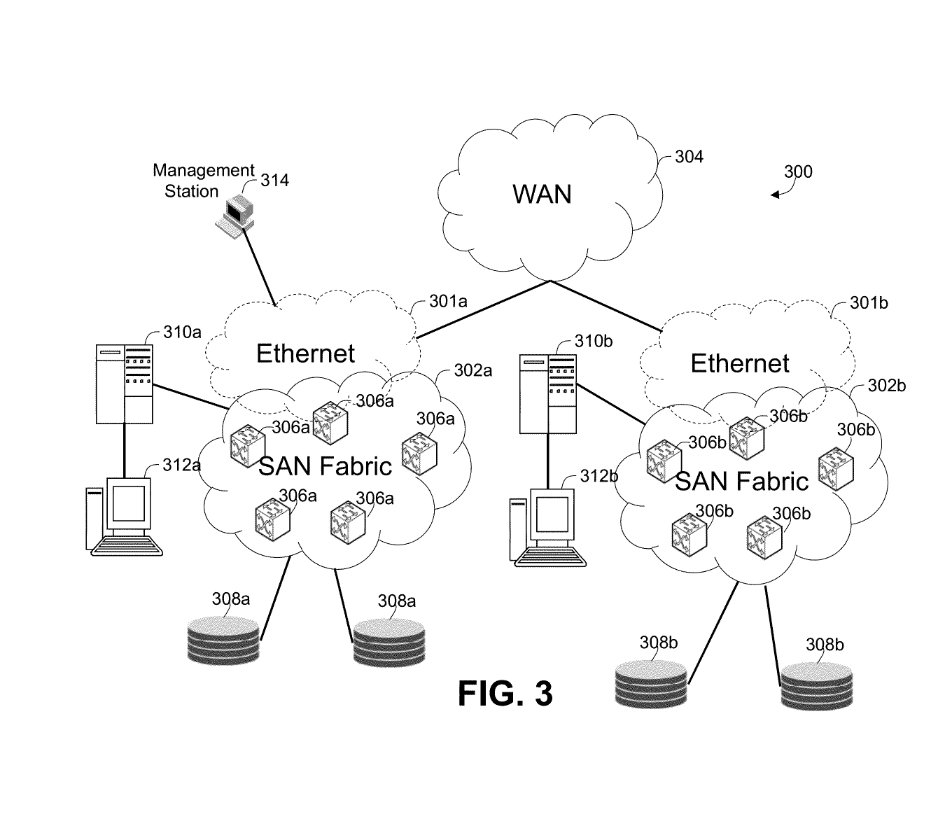

FIG. 3 illustrates a SAN network 300 utilizing the Fibre Channel (FC) protocol. As shown, a plurality of FC SAN fabrics 302a and 302b are interconnected via WAN 304. The SAN fabrics 302a and 302b are comprised of a plurality of FC switches 306a and 306b, respectively. SAN fabric 302a is connected to a plurality of storage devices 308a. Likewise, SAN fabric 302b is connected to a plurality of storage devices 308b. Each SAN fabric 302a and 302b connect their respective storage devices 308a and 308b to application servers 310a and 310b, which are in turn connected to computers 312a and 312b. This configuration allows for computer 312a to access storage devices 308b and for computer 312b to access storage devices 308a. As above, this is an exemplary FC SAN architecture and numerous other FC architectures can be managed according to the present invention.

In an embodiment of the present invention a management station 314 is connected to Ethernet LAN 301a and indirectly to Ethernet LAN 301b via WAN 304. Ethernet LANs 301a and 301b are connected to the Ethernet management ports of the switches 306a and 306b to provide a management network for the switches 306a and 306b. As will be appreciated by one having ordinary skill in the art, the management station 314 allows a network administrator to monitor the data traffic, port utilization, and various other networking characteristics using network management software, such that any data congestion may be alleviated.

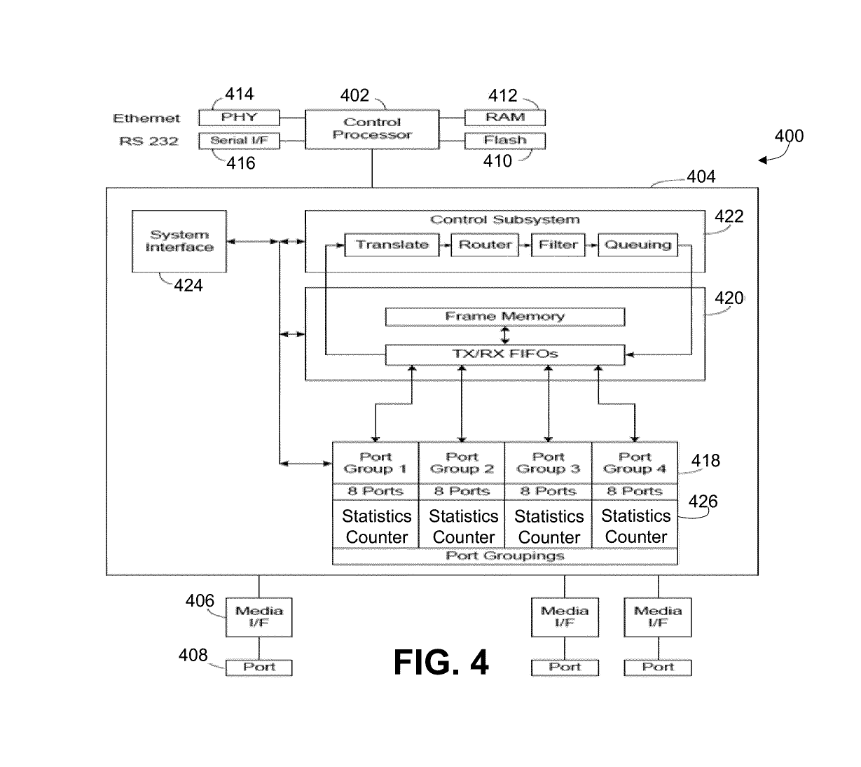

FIG. 4 illustrates a block diagram of a FC switch 400 that may be utilized in accordance with the SAN network 300. A control processor 402 is connected to a switch ASIC 404. The switch ASIC 404 is connected to media interfaces 406 which are connected to ports 408. Generally the control processor 402 configures the switch ASIC 404 and handles higher level switch operations, such as the name server, the redirection requests, and the like. The switch ASIC 404 handles the general high speed inline or in-band operations, such as switching, routing and frame translation. The control processor 402 is connected to flash memory 410 to hold the software, to RAM 412 for working memory and to an Ethernet PHY 414 used for management connection and serial interface 416 for out-of-band management.

The switch ASIC 402 has four basic modules, port groups 418, a frame data storage system 420, a control subsystem 422 and a system interface 424. The port groups 418 perform the lowest level of packet transmission and reception, and include a statistical counter module 426 to allow management software to access the various statistical counters of the switch 400, such as receive and transmit rate counters for each port. Generally, frames are received from a media interface 406 and provided to the frame data storage system 420. Further, frames are received from the frame data storage system 420 and provided to the media interface 406 for transmission out a port 408.

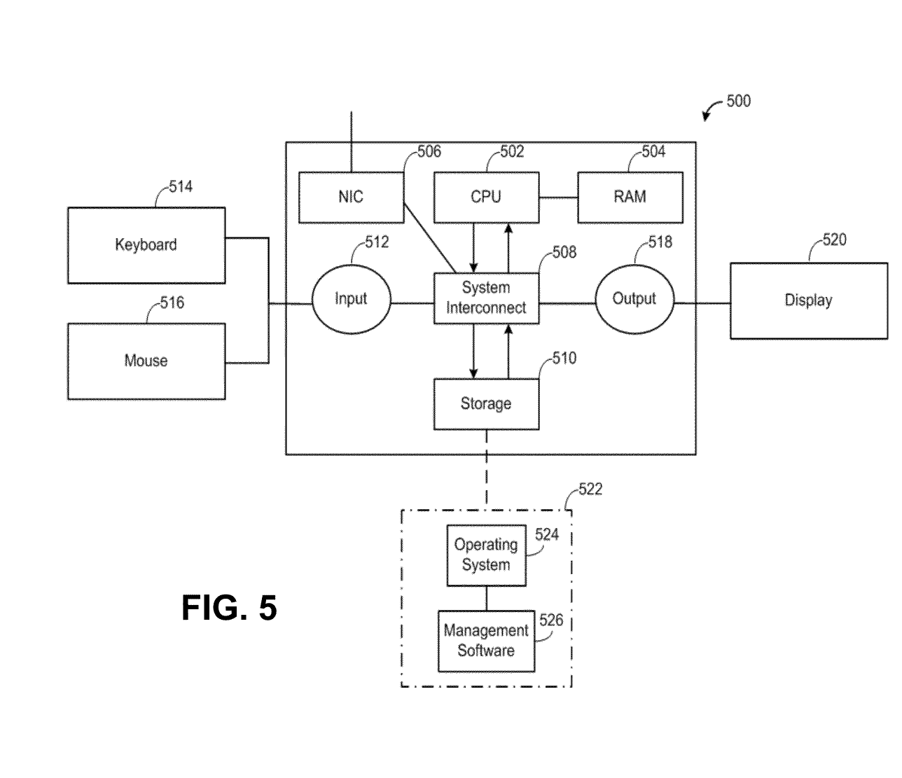

FIG. 5 illustrates a block diagram of a management station 500, similar to management stations 138 and 314, that may be utilized in accordance with the present invention. As shown, the management station 500 is comprised of a central processing unit (CPU) 502, random access memory (RAM) 504, network interface card (NIC) 506, system interconnect 508, storage component 510, input component 512, and output component 518 which are all interconnected via the system interconnect 508. The input component 512 may be connected to an input device such as a keyboard 514 and mouse 516. The output component 518 is connected to a display device 520, such as an LCD monitor. Storage component 510 stores software 522, which typically includes an operating system 524 and network management software 526. The NIC 506 allows the management station 500 to communicate with a network. As understood by those skilled in the art, network management software is typically designed to allow a network administrator to quickly and efficiently monitor and manage a large network via a user interface, often a graphical user interface (GUI). The network management software 526 could be, for example, Brocade Network Advisor by Brocade Communication Systems, Inc. Once booted, the management station 500 loads the operating system 524 from the storage 510 into the RAM 504. From the operating system 524 a user may run the network management software 526, which is then also loaded into the RAM 504. The interface of the network management software 526 is then displayed on the display 520 via the output component 518. The network management software 526 allows a user to monitor numerous parameters or network characteristics, such as the number events on the network, number of unused ports of network devices, memory utilization of network devices, bandwidth utilization of network devices, and CPU utilization of network devices. It is understood that this is an exemplary computer system architecture and numerous other computer architectures can be used according to the present invention.

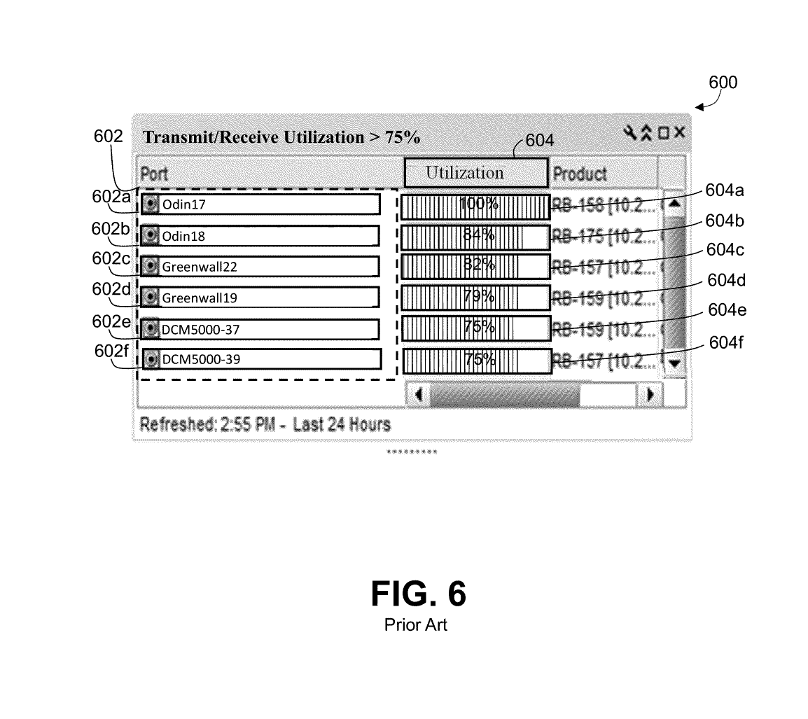

FIG. 6 illustrates an example of a widget 600 of a graphic user interface (GUI) of management software 526 wherein a plurality of network devices 602 are sorted in accordance with one version of the prior art. As understood by those having skill in the art, network management software accumulates the particular characteristics of a network by either: (1) polling switches via application programming interface (API), command line interface (CLI) or simple network management protocol (SNMP); or (2) receiving warnings from switches on the network via API or SNMP. The network management software then displays the particular characteristics (e.g., transmit/receive utilization) being tracked in a window, such as a widget or dashboard, for the network administrator. As shown, the plurality of network devices 602 are sorted in descending order based on the device having a transmit (Tx) or receive (Rx) utilization above a 75% threshold. Consequently, the first device 602a in the arrangement has the highest Tx/Rx utilization value 604a, the second device 602b in the arrangement has the second Tx/Rx utilization value 604b, and the third device 602c in the arrangement has the third highest Tx/Rx utilization value 604c, The remaining devices 602d to 602f are sorted based on their Tx/Rx utilization value in the same manner as devices 602a through 604c. The utilization bar of each device is colored based on the level of utilization. For example, utilization bars 604a to 604f are red to indicate utilization between 75% and 100%. While there are benefits to displaying the parameters of each device in a widget in this fashion, an administrator may be unable to monitor the widget in all circumstances. For example, when the administrator is changing network settings or monitoring portions of a network topology, the administrator may have to close or otherwise turn attention away from the widget window. In that case, the administrator may miss critical network information, which may increase the likelihood of a bottleneck or other network degrading event.

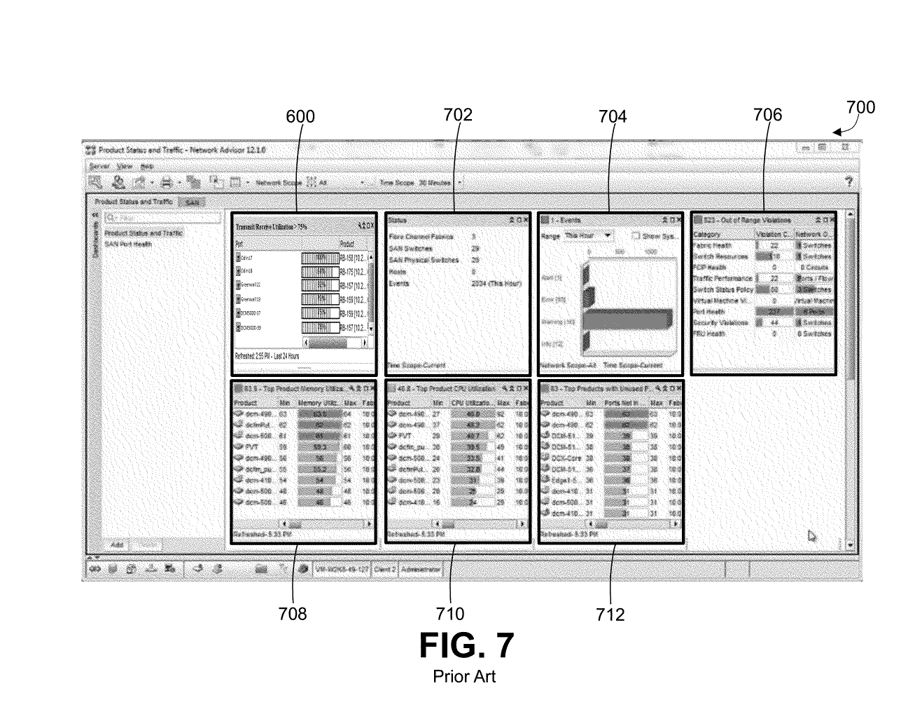

FIG. 7 illustrates an example of multiple GUI widgets of management software 526, wherein a different parameter of the network is being monitored by each individual widget. For purposes of simplicity, the same element numbering will be used for the same elements between different figures. As illustrated, widget 600 is displayed in the same window 700 along with widgets 702 through 712. As previously discussed, widget 600 corresponds network devices having a Tx/Rx utilization value above 75%. Widget 702 corresponds to the overall status of the network, including network events. Widget 704 corresponds to the number of events occurring on the network in the form of a graph. Widget 706 corresponds to the number of “out of range violations” occurring on the network. Widget 708 corresponds to top product memory utilization of the devices on the network. Widget 710 corresponds to top product CPU utilization of the devices on the network. Widget 712 corresponds to the top products with unused ports on the network. While the present embodiment only discloses a few types of monitored network parameters, it would be understood by those having ordinary skill in the art that any type of parameter could be monitored using a widget. For example, a widget may alternatively monitor the number of timeouts occurring on the network or occurring on particular ports. While the widgets may allow an administrator to focus on information critical to the performance of a network, it may be very difficult for an administrator to always keep track of the information displayed in the widgets. More specifically, an administrator will undoubtedly be required to configure the network or focus on other portions of the management software (e.g., the topology view). In that case, the administrator may lose track of the widgets and any changes occurring in those widgets. Even more importantly, the administrator may miss import notifications or network changes that may significantly affect network performance.

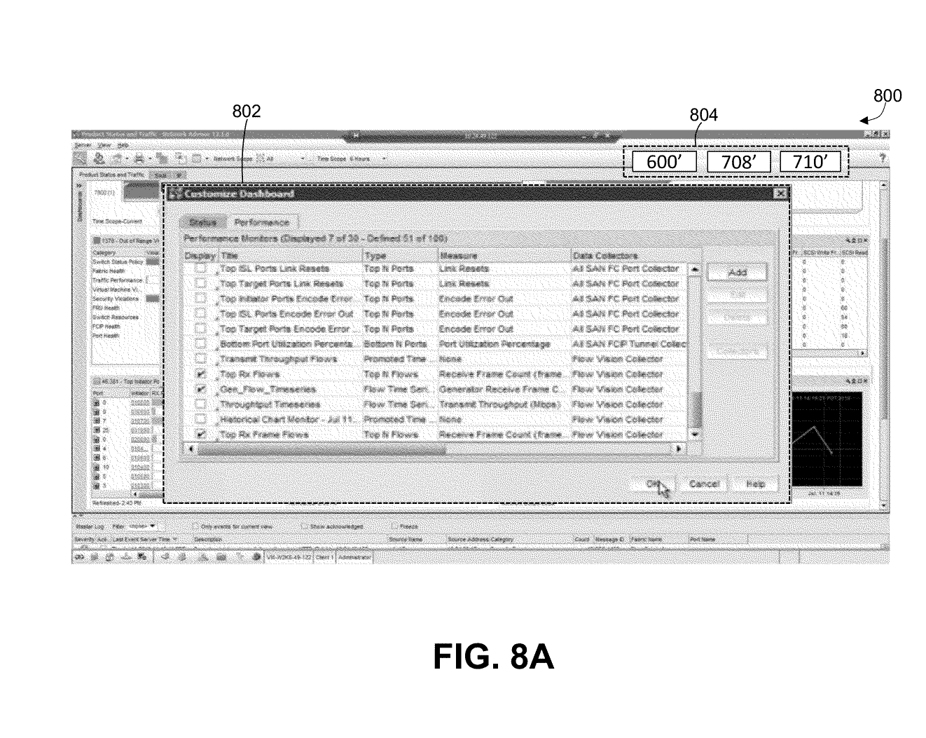

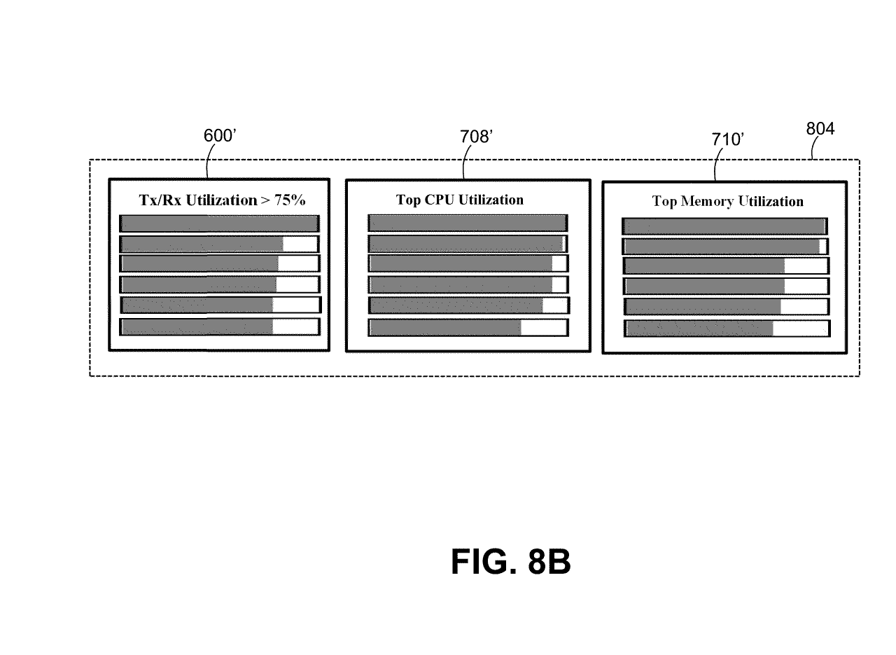

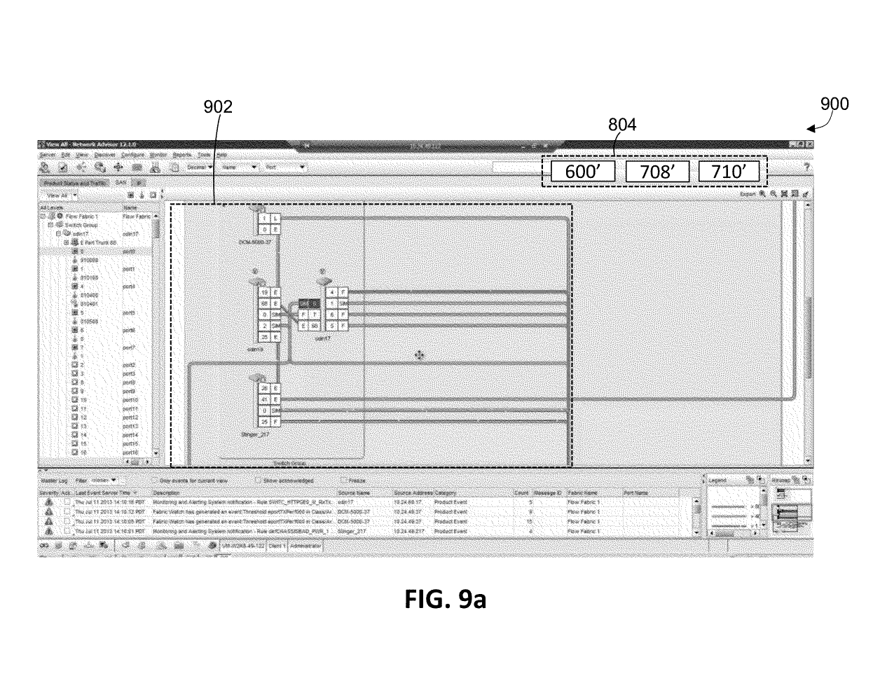

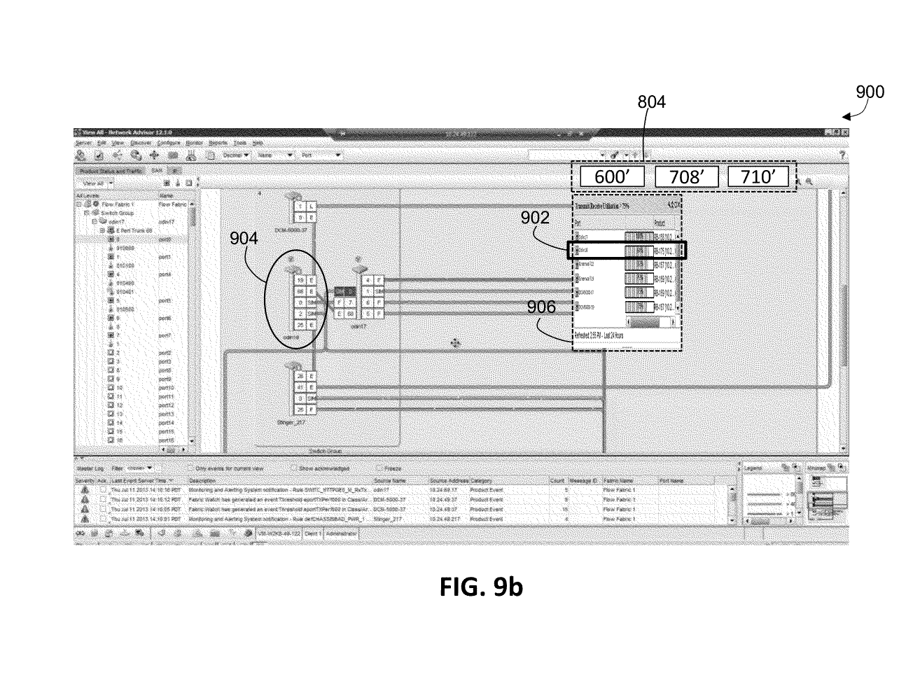

FIG. 8A illustrates a window 800 of the management software 526 in accordance with an embodiment of the present invention. As shown, a dashboard customization window 802 is blocking a significant portion of the window 800 of the network management software 526. Consequently, while the administrator is configuring the dashboards, he may be unable be able to view the information in a particular widget that would normally be visible. However, as illustrated in FIG. 8A, a widget bar 804 is located in the upper right corner of the window 800, wherein the widgets occupy a portion of the GUI window 800. The widget bar 804 includes minimized versions of widgets 600, 708, and 710. When a change occurs relating to any of the information in one of those particular widgets, the widget may flash or otherwise alert the administrator that a change has occurred. For example, minimized widget 600′ may be configured to flash when a port reaches Tx/Rx utilization of 100%. In that case, the minimized widget 600′ would flash because device 602a is at 100% Rx/Tx utilization. Likewise, minimized widget 708′ may be configured to alert the administrator when a certain device exceeds a memory utilization threshold (e.g., 80%). The widget bar 804 may be configured to include any minimized widget desired by the administrator, and it may also be configured to follow the administrator into any portion of the network management software 526. Moreover, the widget bar may be located on any portion of the screen and may be arranged in any manner desired by the administrator (e.g., horizontally or vertically). The widget bar 804 may also be configured to maintain visibility regardless of other activity occurring in other portions of the GUI window 900. For example, even when the administrator goes from the dashboard customization screen 802 to the network topology view 902 illustrated in FIG. 9a, the widgets still maintain visibility in the window. The administrator can select whether the widget bar 804 is always on top or automatically moves to a different part of the GUI window 900 either in the same orientation or a rotated orientation.

An additional feature of the present invention is that the minimized widgets may convey information about the network to the administrator while in fully minimized mode. Turning to FIG. 8B, widget bar 804 includes the three minimized widgets, 600′, 708′, 710′, from FIG. 8A. However, here the minimized widgets also graphically represent information regarding their respective parameters while in fully minimized mode. More specifically, minimized widget 600′ illustrates a small bar graph showing the top six transmit/receive utilizations on the network. Similarly, minimized widget 708′ graphically represents the top CPU utilization of the devices on the network. Finally, minimized widget 710′ graphically represents the top memory utilization of the devices on the network. While the informational representations come in the form of bar graphs here, it would be understood by those having ordinary skill in the art that the representations could be other forms of graphical representations, such as pie charts, line graphs, or the like. It would also be understood that the graphical representations could include colors corresponding to the monitored information. For example, a red bar in minimized widget 708′ may indicate utilization above 90%, while a blue graph indicates utilization between 80%-90%. Moreover, the informational representations could also be textual, or a combination of graphical and textual. For example, rather than showing just the bar graphs in FIG. 8B, the actual value for each graphical bar in the minimized widgets 600′, 708′, 710′ could be overlaid on to the bar to give more detail to the administrator regarding the monitored network information.

An additional feature of the present invention may be the ability of the minimized widgets 600′, 708′, and 710′ to drop down when selected in order to display the information corresponding to the particular widget. For example, clicking on minimized widget 600′ may cause the minimized widget 600′ to fully expand to widget 600, thereby displaying the information from FIG. 6 on top of window 800.

Yet another feature of the present invention may be the ability of the widgets to change states by flashing or otherwise alerting the administrator based on the context of the information being viewed/configured by the administrator. For example, if an administrator is configuring a network device that is listed in widget 600 from FIG. 6, the minimized widget 600′ from FIG. 8A may flash to indicate that the device being configured is currently being monitored by that particular widget. Additionally, if the administrator selects the flashing (or otherwise alerting) minimized widget 600′, then the particular device in the widget window corresponding to the context of the configuration screen may be highlighted or otherwise emphasized to alert the administrator of the particular device in the widget that caused the alert. For example, if the administrator is configuring a network device that is being tracked by widget 600 and the administrator selects minimized widget 600′ when it flashes, the widget 600 would only display the information of the network device being tracked by the widget 600, or alternatively, it would display all of the devices being tracked by widget 600 but it would specifically highlight or emphasize the particular device that caused minimized widget 600′ to flash or alert. While the present embodiment discloses an administrator configuring a particular device as the “context” that causes the widget 600 to flash, it would be understood by those having ordinary skill in the art that the present invention could apply to any context. For example, as opposed to configuring a device corresponding to widget 600, the administrator could simply be viewing the device in a network topology, which would also trigger the flashing. Alternatively, the management software 526 may be configured to automatically display and/or highlight the relevant portion of the information in the widget 600 without any input from the administrator when the context includes information relating to the devices being tracked by widget 600. In this way, the administrator will always be aware when he or she is in some way interacting with a device that is being monitored by widget 600.

Turning to another embodiment of the present invention illustrated in FIG. 9a, a graphic user interface 900 of the management software 526 is shown, which includes a graphical representation of a part of the network topology 902. The widget bar 804 is located in the upper right hand corner of the screen, which includes the same minimized widgets 600′, 708′, 710′ discussed in the previous embodiment.

Turning now to FIG. 9b, when an administrator selects switch 904 (labeled “odin18”), minimized widget 600′ may change states by beginning to flash, indicating that switch 904 is being tracked by widget 600 (see 602a, corresponding to “Odin18”). The administrator may then select minimized widget 600′, which will cause widget 600 to drop down/expand 906 and the information corresponding to switch 904 will be highlighted or otherwise emphasized 902 to alert the administrator to the information in widget 600 that corresponds to the switch selected on the topology. Additionally, if other widgets (e.g., widgets 708 and 710) are tracking information corresponding to switch 904, then their respective minimized widgets too may flash in a manner like widget 600. Alternatively, the drop down widget(s) may only show the information corresponding to the switch selected by the administrator, as opposed to all of the information being tracked by the widget(s). Alternatively, the widget may automatically drop down once the administrator selects switch 904. In this way, the administrator may not be required to take any action in order to show the relevant and seemingly important information being tracked by the corresponding widget.

By using the presently disclosed embodiments, an administrator may be empowered to monitor network changes, even when preoccupied with other activities that would typically not allow the administrator to continue monitoring the relevant dashboards or widgets. Moreover, the present embodiments allow management software to use the context of the information being viewed/evaluated by the administrator to alert (e.g., by flashing) the administrator that a widget is monitoring a particular device parameter corresponding to the context.

While the present embodiment primarily discusses monitoring Tx/Rx utilization with a widget, it would be understood by those of ordinary skill in the art that any network parameter could be implemented as part of the present invention. For example, rather than using a widget to track Tx/Rx utilization, packet loss, hardware errors, timeouts, memory utilization and the like may be monitored instead. Alternatively, all of these and similar statistics could be monitored at the same time using a plurality of different widgets.

While communication networks using the Ethernet and FC protocols, with switches, routers and the like, have been used as the example in the Figures, the present invention can be applied to any type of data communication network.

The above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
monitoring a network parameter of at least one network device using a widget; and
displaying a minimized version of the widget on a portion of a graphic user interface (GUI), wherein the portion maintains visibility over other portion(s) of the GUI,
wherein the minimized version of the widget is configured to change states based upon a selected event.

2. The method of claim 1, wherein the selected event is a monitored network parameter of the widget reaching a predetermined threshold.

3. The method of claim 1, wherein the selected event is the context of the other portion(s) of the GUI directly corresponding to the at least one network device.

4. The method of claim 1, wherein the state change is a flashing of the minimized widget.

5. The method of claim 1, wherein the state change is opening the widget.

6. A non-transitory computer readable storage medium or media having computer-executable instructions stored therein for an application which performs the following method, the method comprising:
monitoring a network parameter of at least one network device using a widget; and
displaying a minimized version of the widget on a portion of a graphic user interface (GUI), wherein the portion maintains visibility over other portion(s) of the GUI,
wherein the minimized version of the widget is configured to change states based upon a selected event.

7. The non-transitory computer readable storage medium or media of claim 6, wherein the selected event is a monitored network parameter of the widget reaching a predetermined threshold.

8. The non-transitory computer readable storage medium or media of claim 6, wherein the selected event is the context of the other portion(s) of the GUI directly corresponding to the at least one network device.

9. The non-transitory computer readable storage medium or media of claim 6, wherein the state change is a flashing of the minimized widget.

10. The non-transitory computer readable storage medium or media of claim 6, wherein the state change is opening the widget.

11. A computer system comprising:
a processor;
a display device coupled to said processor; and
storage coupled to said processor and storing computer-executable instructions for an application which cause said processor to perform the following steps:
monitoring a network parameter of at least one network device using a widget; and
displaying a minimized version of the widget on a portion of a graphic user interface (GUI), wherein the portion maintains visibility over other portion(s) of the GUI,
wherein the minimized version of the widget is configured to change states based upon a selected event.

12. The system of claim 11, wherein the selected event is a monitored network parameter of the widget reaching a predetermined threshold.

13. The system of claim 11, wherein the selected event is the context of the other portion(s) of the GUI directly corresponding to the at least one network device.

14. The system of claim 11, wherein the state change is a flashing of the minimized widget.

15. The system of claim 11, wherein the state change is opening the widget.
